(19) United States
(12) Patent Application Publication
(10) Pub. No.: US 2019/0385191 A1
(43) Pub. Date: Dec. 19, 2019

(54) DIGITAL ADVERTISEMENT PLATFORM

(71) Applicant: MASTERCARD INTERNATIONAL INCORPORATED, Purchase, NY (US)

(72) Inventors: Gary James Becus, Leichhardt (AU); Hendrik Alexander Gilchrist Kleinsmiede, Tunbridge Wells (GB); Patricia Littler, London (GB); Sarah Cunningham, Dublin (IE); Isabela Peixoto Campos, São Paulo (BR); Marcelo Xavier Sobrinho e Silva, Cooper City, FL (US); Rahul Deshpande, Chesterfield, MO (US); Gerard J. O'Donnell, Wentzville, MO (US); Alison Beth Giordano, New Rochelle, NY (US); I-Hsin Chuang, Brooklyn, NY (US); Samir Kothari, Menlo Park, CA (US); John McCabe, San Carlos, CA (US)

(21) Appl. No.: 16/440,276

(22) Filed: Jun. 13, 2019

Related U.S. Application Data
(60) Provisional application No. 62/833,411, filed on Apr. 12, 2019.
(60) Provisional application No. 62/687,077, filed on Jun. 19, 2018.

(51) Int. Cl. G06Q 30/02

(52) U.S. Cl. CPC G06Q 30/0249; G06Q 30/0276

(57) ABSTRACT

A digital advertisement platform with redemption feedback. In one embodiment, a server including a communication interface, a memory, and an electronic processor. The electronic processor is configured to receive transaction information from the data storage server, generate operation recommendations based on the transaction information that is received from the data storage server, generate operation creation and workflow with an enterprise platform and based on the operation recommendations, and generate a graphical user interface for displaying on the supplier interface device, the graphical user interface based on the operation creation and workflow.

### CROSS-REFERENCE TO RELATED APPLICATIONS

This application claims the benefit of U.S. Provisional Patent Application No. 62/687,077, filed on Jun. 19, 2018, and U.S. Provisional Patent Application No. 62/833,411, filed on Apr. 12, 2019, the entire contents of which are hereby incorporated by reference.

### FIELD

The present disclosure relates generally to a digital advertisement platform. More specifically, the present disclosure relates to digital advertisement platform with redemption feedback.

### BACKGROUND

In conventional digital advertisement systems, a supplier (also referred to herein as a “merchant”) leverages an advertising agency and ad/media network to distribute a digital advertisement operation (also referred to herein as “campaign). For example, the advertiser places online advertisements in webpages or smartphone applications that are targeted to various consumers. Additionally or alternatively, the advertiser sends digital advertisements that are targeted to various consumers. For example, the advertiser may send targeted offers to various consumers.

However, in conventional digital advertisement, the supplier lacks control or access to the digital advertisement operation. The supplier also does not know how consumers may react to the digital advertisement operation. Moreover, in conventional digital advertisement, the supplier does not know the effectiveness of the digital advertisement operation because the supplier does not know how many transactions have occurred due to the digital advertisement operation.

### SUMMARY

In an embodiment, a server of the present disclosure solves the problems associated with conventional digital advertisement. A supplier has direct control and access to a digital advertisement operation with the server of the present disclosure. A supplier also receives operation reporting and analysis from the server, which provides an estimation on how consumers may react to the digital advertisement operation and a forecast of the outcome and required budget prior to execution. Moreover, a supplier will know the effectiveness of the digital advertisement operation because the server will indicate how many transactions have occurred due to the digital advertisement operation.

For example, in one embodiment as indicated above, the present disclosure includes a server. The server includes a communication interface, a memory, and an electronic processor communicatively connected to the memory. The communication interface is configured to communicate with a supplier interface device, communicate with a vehicle-holder interface device, and communicate with a data storage server. The electronic processor is configured to receive transaction information from the data storage server, generate operation recommendations based on the transaction information that is received from the data storage server, generate operation creation and workflow with the enterprise platform and based on the operation recommendations, and generate a graphical user interface for displaying on the supplier interface device, the graphical user interface based on the operation creation and workflow.

In another embodiment, the present disclosure includes a system including a supplier interface device, a vehicle-holder interface device, a data storage server, and a server. The server includes a communication interface, a memory, and an electronic processor communicatively connected to the memory. The communication interface is configured to communicate with the supplier interface device, communicate with the vehicle-holder interface device, and communicate with the data storage server. The electronic processor configured to receive transaction information from the data storage server, generate operation recommendations based on the transaction information that is received from the data storage server, generate operation creation and workflow with the enterprise platform and based on the operation recommendations, and generate a graphical user interface for displaying on the supplier interface device, the graphical user interface based on the operation creation and workflow.

In another embodiment, the present disclosure includes a method. The method includes receiving, with a server, transaction information from a data storage server. The method includes generating, with the server, operation recommendations based on the transaction information that is received from the data storage server. The method includes generating, with the server, an operation creation and workflow with an enterprise platform and based on the operation recommendations. The method also includes generating, with the server, a graphical user interface for displaying on a supplier interface device, the graphical user interface based on the operation creation and workflow.

In yet another embodiment, the present disclosure includes a non-transitory computer-readable medium. The non-transitory computer-readable medium includes instructions that, when executed by an electronic processor, cause the electronic processor to perform a set of operations. The set of operations includes receiving transaction information from a data storage server. The set of operations includes generating operation recommendations based on the transaction information that is received from the data storage server. The set of operations includes generating an operation creation and workflow with an enterprise platform and based on the operation recommendations. The set of operations also includes generating a graphical user interface for displaying on a supplier interface device, the graphical user interface based on the operation creation and workflow.

Other aspects of the embodiments will become apparent by consideration of the detailed description and accompanying drawings.

### BRIEF DESCRIPTION OF THE DRAWINGS

FIG. 1 is a block diagram illustrating a digital advertisement system.

FIG. 2 is a diagram illustrating a first example of relationships between various components of the digital advertisement system of FIG. 1.

FIGS. 3-15 are example graphical user interfaces illustrating the market insights, the consumer insights, the campaign reporting and analytics generated and output by the digital advertisement system of FIG. 1.

FIGS. 16-18 are flowcharts illustrating example methods performed by the digital advertisement system of FIG. 1.

FIG. 19 is a diagram illustrating a second example of relationships between various components of the digital advertisement system of FIG. 1.

### DETAILED DESCRIPTION OF EXEMPLARY EMBODIMENTS

Before any embodiments of the present disclosure are explained in detail, it is to be understood that the present disclosure is not limited in its application to the details of construction and the arrangement of components set forth in the following description or illustrated in the following drawings. The present disclosure is capable of other embodiments and of being practiced or of being carried out in various ways.

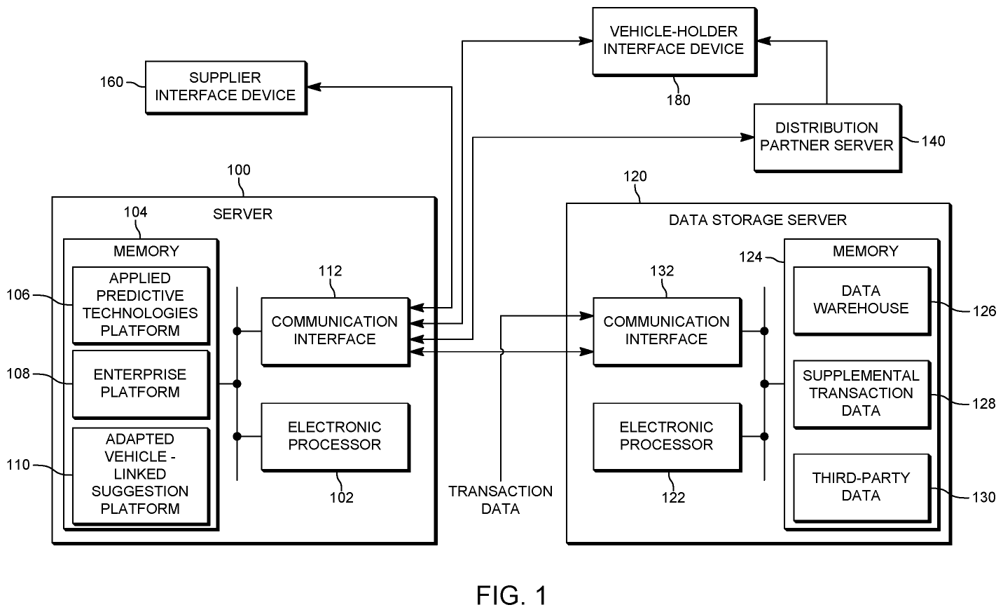

FIG. 1 is a block diagram illustrating a digital advertisement system 10. It should be understood that, in some embodiments, there are different configurations from the configuration illustrated in FIG. 1. The functionality described herein may be extended to any number of servers providing distributed processing.

In the example of FIG. 1, the digital advertisement system 10 includes a server 100, a data storage server 120, a distribution partner server 140, a supplier interface device 160 (hereinafter referred to as “merchant interface device 160”), and a vehicle-holder interface device 180 (hereinafter referred to as “cardholder interface device 180”). In some examples, the merchant interface device 160 may be a personal desktop computer, a laptop computer, a tablet computer, a personal digital assistant, a mobile phone, or other suitable computing device. Similarly, in some examples, the cardholder interface device 180 may be a personal desktop computer, a laptop computer, a tablet computer, a personal digital assistant, a mobile phone, or other suitable computing device.

The server 100 includes an electronic processor 102 (for example, a microprocessor or another suitable processing device), a memory 104 (for example, a non-transitory computer-readable storage medium), and a communication interface 112. It should be understood that, in some embodiments, the server 100 may include fewer or additional components in configurations different from that illustrated in FIG. 1. Also the server 100 may perform additional functionality than the functionality described herein. In addition, the functionality of the server 100 may be incorporated into other servers. As illustrated in FIG. 1, the electronic processor 102, the memory 104, and the communication interface 112 are electrically coupled by one or more control or data buses enabling communication between the components.

The electronic processor 102 executes machine-readable instructions stored in the memory 104. For example, the electronic processor 102 may execute instructions stored in the memory 104 to perform the functionality described herein.

The memory 104 may include a program storage area (for example, read only memory (ROM)) and a data storage area (for example, random access memory (RAM), and other non-transitory, machine-readable medium). In some examples, the program storage area may store the instructions regarding an applied predictive technologies (APT) platform 106 (hereinafter referred to as “applied predictive technologies (APT) program 106”), an enterprise platform 108 (hereinafter referred to as “enterprise offer program (EOP) 108”), an adapted vehicle-linked suggestion platform 110 (hereinafter referred to as “personalized card-linked offer (PCLO) program 110”), and an optional integrated marketing platform (IMP) program 111.

The applied predictive technologies program 106 has machine-readable instructions that cause the electronic processor 102 to process (e.g., retrieve) transaction information from the data storage server 120 and generate information based on the transaction information. In particular, the electronic processor 102, in performing the applied predictive technologies program 106, uses machine learning to generate and output market insights, consumer insights, data visualization (e.g., operation reporting and analytics, hereinafter referred to as “campaign reporting and analytics”), and operation recommendations (hereinafter referred to as “campaign recommendations”). Alternatively, in some examples, the campaign recommendations output from performing the applied predictive technologies program 106 may be generated and output by a different stand-alone program, for example, a campaign recommendations program.

Machine learning generally refers to the ability of a computer program to learn without being explicitly programmed. In some embodiments, a computer program (for example, a learning engine) is configured to construct an algorithm based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, inductive logic programming, support vector machines, clustering, Bayesian networks, reinforcement learning, representation learning, similarity and metric learning, sparse dictionary learning, and genetic algorithms. Using one or more of the approaches described above, a computer program can ingest, parse, and understand data and progressively refine algorithms for data analytics.

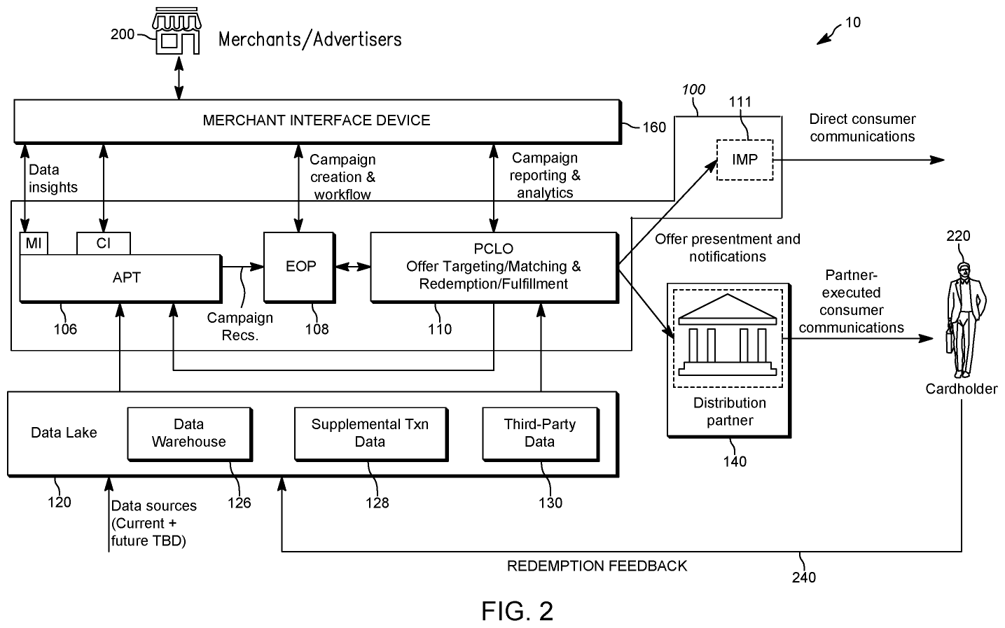

The enterprise offer program 108 has machine-readable instructions that, when executed by the electronic processor 102, cause the electronic processor 102 to process campaign recommendations output by performing the applied predictive technologies program 106, and generate and output an operation creation and workflow (hereinafter referred to as “campaign creation and workflow”) based on the campaign recommendations. The electronic processor 102, in performing the enterprise offer program 108, then receives information defining a specific campaign from a merchant based on the merchant's use of the campaign creation and workflow, as described in greater detail below in FIG. 2.

The personalized card-linked offer program 110 has machine-readable instructions that, when executed by the electronic processor 102, cause the electronic processor 102 to process the information defining the specific campaign that is output from performing the enterprise offer program 108. In particular, the electronic processor 102, in performing the personalized card-linked offer program 110, receives transaction information from the data storage server 120 and determines a plurality of targets (e.g., a plurality of cardholders) based on the transaction information that is received and the information defining the specific campaign. Upon determining a plurality of targets, the electronic processor 102, in performing the personalized card-linked offer program 110, generates an offer presentment and notifications for each of the plurality of targets. In some examples, the electronic processor 102, in performing the personalized card-linked offer program 110, outputs the offer presentment and notifications to the distribution partner server 140 for partner-executed consumer communications. In other examples, the electronic processor 102, in performing the personalized card-linked offer program 110, outputs the offer presentment and notifications to be processed by performing the optional integrated marketing program 111 for direct consumer communications from the server 100. For example, the electronic processor 102, in performing the optional integrated marketing program 111, may control the communication interface 112 to output the offer present and notifications directly to the cardholder interface device 180.

The communication interface 112 receives data from and provides data to devices external to the server 100, such as the data storage server 120, the distribution partner server 140, the merchant interface device 160, and the cardholder interface device 180. For example, the communication interface 112 may include a port or connection for receiving a wired connection (for example, an Ethernet cable, fiber optic cable, a telephone cable, or the like), a wireless transceiver, or a combination thereof. In some examples, the communication interface 112 may communicate with one or more of the data storage server 120, the distribution partner server 140, the merchant interface device 160, and the cardholder interface device 180 via the internet.

In the example of FIG. 1, the data storage server 120 includes an electronic processor 122 (for example, a microprocessor or another suitable processing device), a memory 124 (for example, a non-transitory computer-readable storage medium), and a communication interface 132. It should be understood that, in some embodiments, the data storage server 120 may include fewer or additional components in configurations different from that illustrated in FIG. 1. Also the data storage server 120 may perform additional functionality than the functionality described herein. In addition, the functionality of the data storage server 120 may be incorporated into other servers (e.g., incorporated into the server 100). As illustrated in FIG. 1, the electronic processor 122, the memory 124, and the communication interface 132 are electrically coupled by one or more control or data buses enabling communication between the components.

The electronic processor 122 executes machine-readable instructions stored in the memory 124. For example, the electronic processor 122 may execute instructions stored in the memory 124 to perform the functionality described herein.

The memory 124 may include a program storage area (for example, read only memory (ROM)) and a data storage area (for example, random access memory (RAM), and other non-transitory, machine-readable medium). The data storage area includes a data warehouse 126, supplemental transaction data 128, and third-party data 130.

The data warehouse 126 is transaction data derived from the processing of card-based payments for a plurality of cardholders. The supplemental transaction data 128 is transaction data that is external to a payment processor. In some examples, the supplemental transaction data 128 is third-party transaction data associated with and supporting a loyalty program of the payment processor. Additionally, in some examples, the supplemental transaction data 128 may also include third-party profile data on cardholders. The third-party data 130 is data received from a third-party that characterizes attributes associated with the plurality of cardholders.

The communication interface 132 receives data from and provides data to devices external to the data storage server 120, i.e., the server 100 and a payment processing server (not shown). For example, the communication interface 132 may include a port or connection for receiving a wired connection (for example, an Ethernet cable, fiber optic cable, a telephone cable, or the like), a wireless transceiver, or a combination thereof. In some examples, the communication interface 132 may be communicatively connected to the communication interface 112 via a backhaul. In some examples, the communication interface 132 may receive transaction data from a payment processing server (not shown).

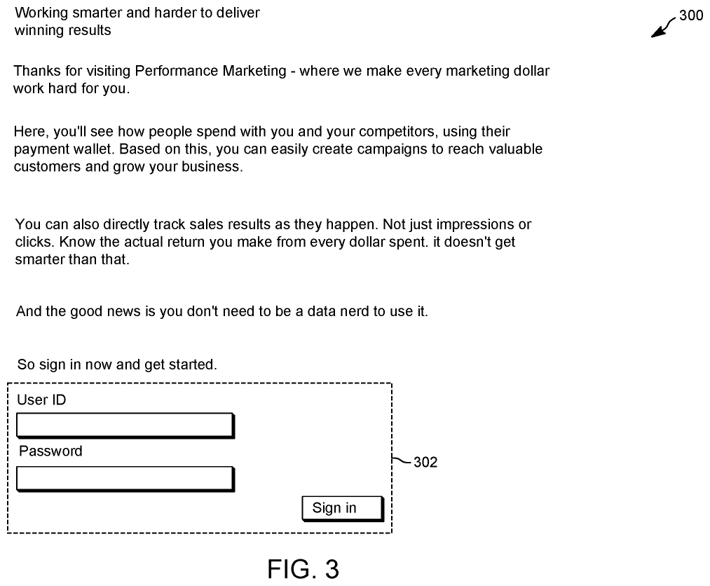

In some examples, the server 100 includes one or more graphical user interfaces (as described in greater detail below and illustrated in FIGS. 3-15) and one or more user interfaces (not shown). The one or more graphical user interfaces (e.g., one or more webpages) including graphical elements that allow a user of the merchant interface device 160 to interface with the server 100. The one or more graphical user interfaces may include, or be part of, a display screen that displays the market insights, the consumer insights, and the campaign reporting and analytics generated and output by the electronic processor 102 in performing the applied predictive technologies program 106. Additionally, the one or more graphical user interfaces may include, or be part of, a display screen that displays the campaign creation and workflow generated and output by the electronic processor 102 in performing the enterprise offer program 108.

In some examples, the server 100 includes one or more user interfaces (not shown). The one or more user interfaces include one or more input mechanisms (for example, a touch screen, a keypad, a button, a knob, and the like), one or more output mechanisms (for example, a display, a printer, a speaker, and the like), or a combination thereof. The one or more optional user interfaces receive input from a user, provide output to a user, or a combination thereof. In some embodiments, as an alternative to or in addition to managing inputs and outputs through the one or more optional user interfaces, the server 100 may receive user input, provide user output, or both by communicating with an external device (e.g., the merchant interface device 160 or a workstation (not shown)) over a wired or wireless connection.

In other examples, the server 100 outputs offer presentment and notifications to the distribution partner server 140 via the communication interface 112. The distribution partner server 140 includes one or more graphical user interfaces (not shown) and one or more user interfaces (not shown). The one or more graphical user interfaces (e.g., one or more webpages) including graphical elements that allow a user of the cardholder interface device 180 to interface with the distribution partner server 140. The one or more graphical user interfaces may include, or be part of, a display screen that displays the offer presentment and notifications generated and output by the server 100.

FIG. 2 is a diagram illustrating a first example of relationships between various components of the digital advertisement system 10 of FIG. 1. In the example of FIG. 2, the digital advertisement system 10 includes the server 100, the data storage server 120, the distribution partner server 140, the merchant interface device 160, and the cardholder interface device 180. Additionally, in the example of FIG. 2, the digital advertisement system 10 further includes a merchant 200 and a targeted cardholder 220.

As illustrated in FIG. 2, the electronic processor 102, in performing the applied predictive technologies program 106, retrieves information from the data storage server 120, and in the case of an existing campaign, information generated by performing the personalized card-linked offer program 110. Upon receiving the information from the data storage server 120, the electronic processor 102, in performing the applied predictive technologies program 106, uses machine learning to generate market insights, consumer insights, and campaign recommendations.

The electronic processor 102, in performing the applied predictive technologies program 106, outputs the campaign recommendations that are generated to the enterprise offer program 108. The electronic processor 102, in performing the enterprise offer program 108, generates a campaign creation and workflow based on the campaign recommendations. The electronic processor 102 controls the communication interface 112 to output the campaign creation and workflow to the merchant interface device 160. For example, the electronic processor 102 generates a webpage for the merchant interface device 160 to access. The webpage includes the campaign creation and workflow. The electronic processor 102 then receives information defining a specific campaign from the merchant 200 based on the merchant's use of the campaign creation and workflow in the webpage. In this way, the merchant 200 has direct access to the enterprise offer program 108 and the specific creation of a campaign in the server 100.

As illustrated in FIG. 2, the electronic processor 102, in performing the personalized card-linked offer program 110, receives transaction information from the data storage server 120 and determines a plurality of targets (e.g., a plurality of cardholders including the cardholder 220) based on the transaction information that is received and the information defining the specific campaign. Upon determining a plurality of targets, the electronic processor 102, in performing the personalized card-linked offer program 110, generates an offer presentment and notifications for each of the plurality of targets. In some examples, the electronic processor 102 controls the communication interface 112 to output the offer presentment and notifications to the distribution partner server 140 for partner-executed consumer communications. In other examples, the electronic processor 102, in performing the optional integrated marketing program 111, controls the communication interface 112 to output the offer presentment and notifications for direct consumer communications from the server 100. For example, the electronic processor 102 may control the communication interface 112 to output the offer present and notifications directly to the cardholder interface device (not shown) and the cardholder 220.

Additionally, as illustrated in FIG. 2, the electronic processor 102, in performing the personalized card-linked offer program 110, retrieves information from the data storage server 120, and in the case of an existing campaign, information generated by performing the personalized card-linked offer program 110. Upon receiving the information from the data storage server 120, the electronic processor 102, in performing the personalized card-linked offer program 110, uses machine learning to generate data visualization (e.g., campaign reporting and analytics).

The electronic processor 102 outputs the market insights and consumer insights generated by the applied predictive technologies program 106 and the data visualization generated by the personalized card-linked offer program 110 to the merchant interface device 160. For example, the electronic processor 102 generates a webpage that is accessible by the merchant interface device 160. The webpage includes the market insights, the consumer insights, and the data visualization. In this way, the merchant 200 has direct access to the insights generated by the applied predictive technologies program 106 and the ongoing analytics of an existing campaign or predictions for a future campaign generated by the personalized card-linked offer program 110.

In some embodiments, the cardholder 220 may be required to activate the offer from the server 100. Upon activation by the cardholder 220, the offer may be redeemed by satisfying the offer. The electronic processor 102, in performing the personalized card-linked offer program 110, determines the offer has been satisfied based on the transaction data associated with the cardholder 220 that indicates a redemption by the cardholder 220 (illustrated by the redemption feedback 240). Upon redemption of the offer, electronic processor 102, in performing the personalized card-linked offer program 110, outputs a fulfillment notification to the cardholder 220 and applies the incentive of the offer to the account of the cardholder 220. Additionally, upon redemption of the offer, the electronic processor 102, in performing the personalized card-linked offer program 110, outputs the fulfillment information for use by the electronic processor 102 in performing the applied predictive technologies program 106.

In other embodiments, the offer to the cardholder 220 may be pre-activated by the server 100. The offer may be redeemed simply by satisfying the offer. The electronic processor 102, in performing the personalized card-linked offer program 110, determines the offer has been satisfied based on the transaction data associated with the cardholder 220 that indicates a redemption by the cardholder 220 (illustrated by the redemption feedback 240). Upon redemption of the offer, the electronic processor 102, in performing the personalized card-linked offer program 110, outputs a fulfillment notification to the cardholder 220 and applies the incentive of the offer to the account of the cardholder 220. Additionally, upon redemption of the offer, the electronic processor 102, in performing the personalized card-linked offer program 110, outputs the fulfillment information for use in performing the applied predictive technologies program 106.

The electronic processor 102, in performing the applied predictive technologies program 106, updates the campaign reporting and analytics based on the fulfillment information received from performing the personalized card-linked offer program 110. Upon updating the campaign reporting and analytics, the merchant 200 may see the fulfillment by the cardholder 220 on the webpage. In some examples, the merchant 200 may see the fulfillment by the cardholder 220 on the webpage and in real-time. In other examples, the merchant 200 may see the fulfillment by the cardholder 220 on the webpage and in near real-time (e.g., within the same day). In yet other examples, the merchant 200 may see the fulfillment by the cardholder 220 on the webpage and within twenty-four to forty-eight hours.

FIGS. 3-15 are example graphical user interfaces 300-1500 illustrating the market insights, the consumer insights, the campaign reporting and analytics, and the campaign creation and workflow generated and output by the digital advertisement system of FIG. 1. As explained above, some or all of the example graphical user interfaces 300-1500 may include, or be part of, a display screen that displays the market insights, the consumer insights, and the campaign reporting and analytics output by the applied predictive technologies program 106. Additionally, some or all of the example graphical user interfaces 300-1500 may include, or be part of, a display screen that displays the campaign creation and workflow output by the enterprise offer program 108.

As illustrated in FIG. 3, a first example graphical user interface 300 includes a merchant sign-on section 302. The merchant sign-on section 302 secures a customized merchant account for a particular merchant that generates and outputs the market insights, the consumer insights, the campaign reporting and analytics, and the campaign creation and workflow as described above. Further, the “customization” of the merchant account is in the customization of the market insights, the consumer insights, the campaign reporting and analytics, and the campaign creation and workflow based on existing transaction data that is associated with the particular merchant.

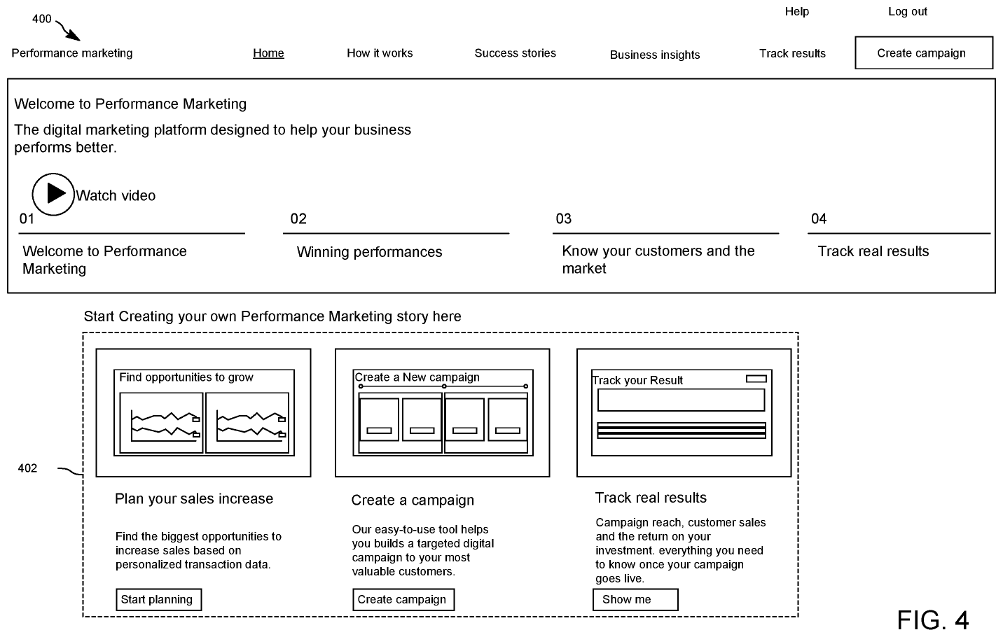

As illustrated in FIG. 4, a second example graphical user interface 400 includes a high-level overview section 402 of the customized merchant account. The high-level overview section 402 includes several subsections, specifically, 1) Plan your sales increase subsection (market and consumer insights as described above), 2) Create a campaign subsection (campaign creation and workflow as described above), and 3) Track real results subsection (campaign reporting and analytics as described above).

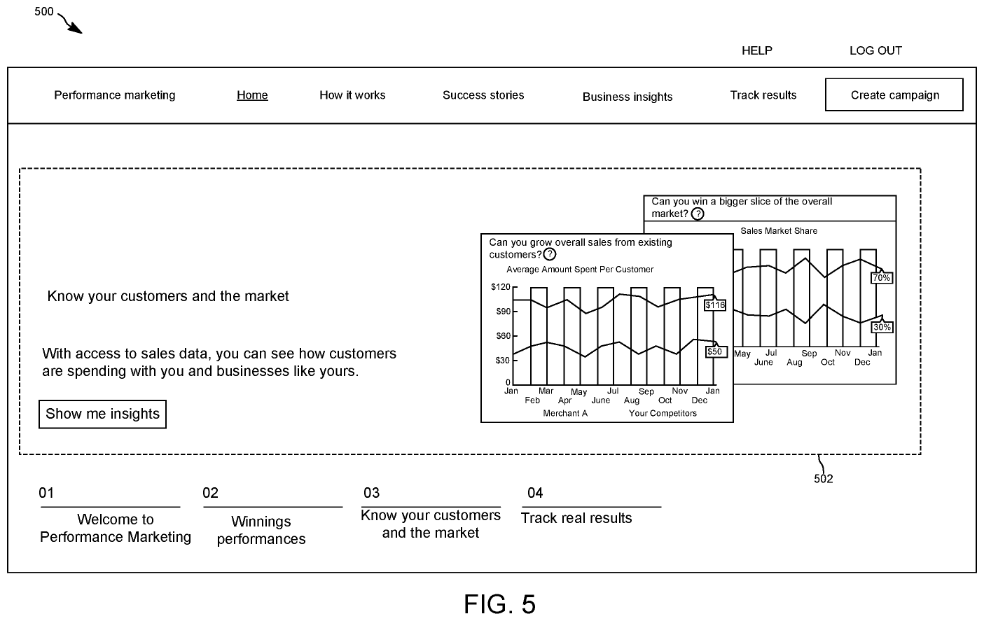

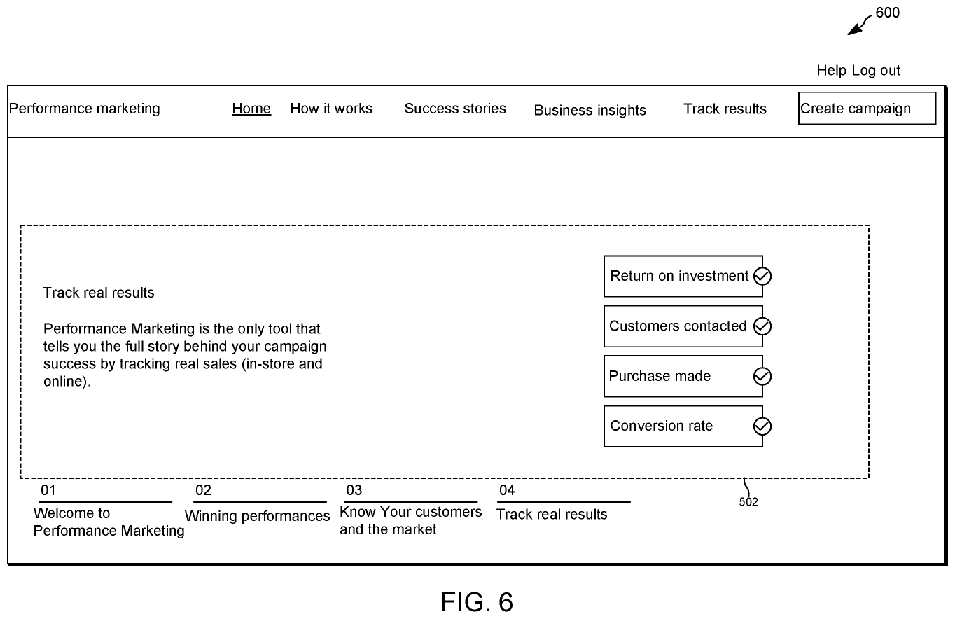

As illustrated in FIG. 5, a third example graphical user interface 500 includes an insights section 502 (market and consumer insights as described above) of the customized merchant account. As illustrated in FIG. 6, a fourth example graphical user interface 600 includes a track results section 602 (campaign report and analytics as described above) of the customized merchant account.

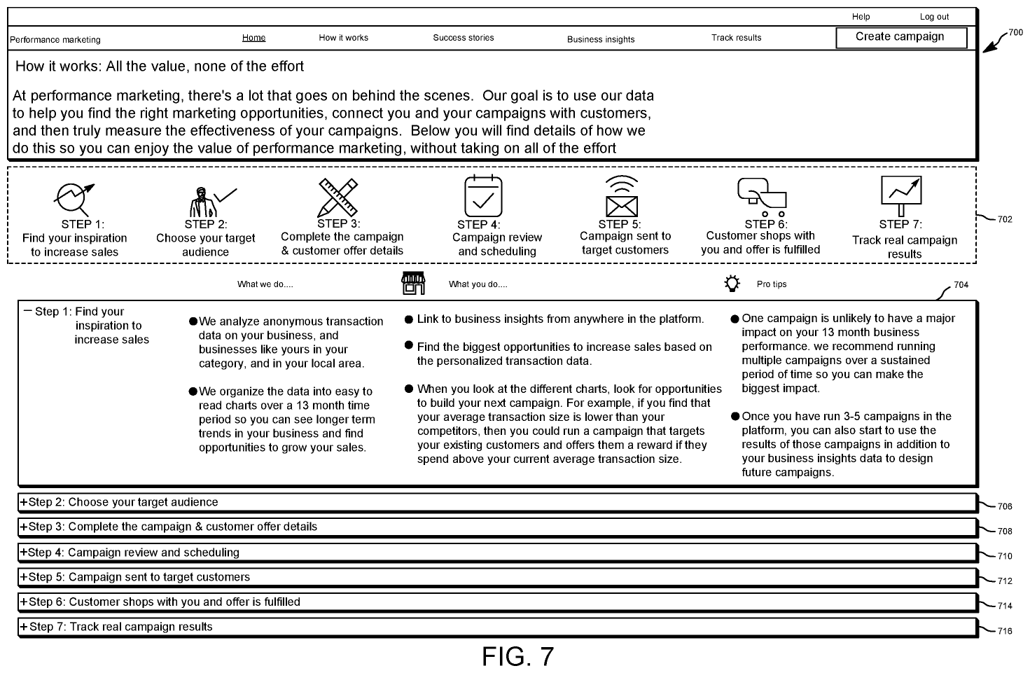

As illustrated in FIG. 7, a fifth example graphical user interface 700 includes a detailed overview section 702 of the customized merchant account and corresponding subsections 704-716. The detailed overview section 702 includes several steps: 1) Find your inspiration to increase sales, 2) Choose your target audience, 3) Complete the campaign and customer offer details, 4) Campaign review and scheduling, 5) Campaign sent to target customers, 6) Customer shops with merchant and fulfills offer, and 7) Track real campaign results.

The subsection 704 corresponds to step 1) Find your inspiration to increase sales. The subsection 704 indicates that the server 100 analyze anonymous transaction data regarding the merchant's business, businesses in the same category as the merchant, and businesses in the local area of the merchant. The subsection 704 also indicates that the server 100 generates business insights to enable the merchant to find the biggest opportunities to increase sales based on the personalized transaction data.

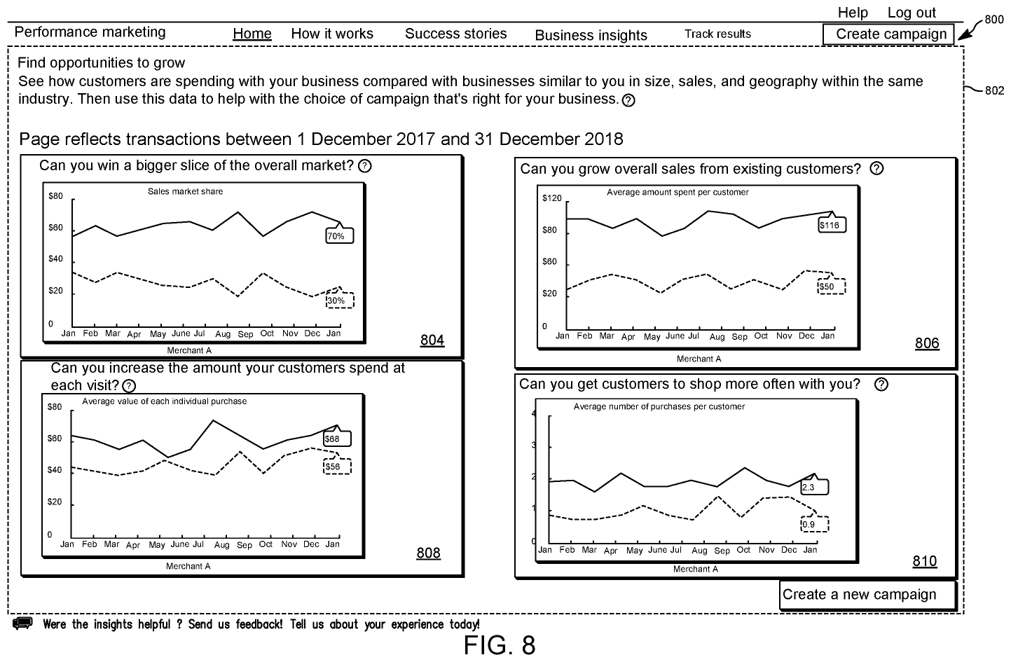

As illustrated in FIG. 8, a sixth example graphical user interface 800 is a more detailed overview section 802 from the insights section 520 and includes several example charts 804-810 based on anonymous transaction data. A first example chart 804 illustrates the sales market share of the merchant and the merchant's competitors based on the anonymous transaction data. Specifically, in the example of FIG. 8, the merchant has a 30% market share and the merchant's competitors have a 70% market share at the end of a twelve month time period. From this example chart 804, the merchant has an insight into the merchant's market share being 30% that the merchant may attempt to increase with a customized campaign offer.

A second example chart 806 illustrates the average amount spent per customer at the merchant and at the merchant's competitors based on the anonymous transaction data. Specifically, in the example of FIG. 8, the merchant has a $50 average amount spent per customer and the merchant's competitors have a $116 average amount spent per customer at the end of a twelve month time period. From this example chart 806, the merchant has an insight into a gap of $66 dollars with respect to the merchant's competitors that the merchant may attempt to reduce or eliminate with a customized campaign offer.

A third example chart 808 illustrates the average value of each individual purchase at the merchant and at the merchant's competitors based on the anonymous transaction data. Specifically, in the example of FIG. 8, the merchant has a $56 average value of each individual purchase and the merchant's competitors have a $68 average amount spent per customer at the end of a twelve month time period. From this example chart 808, the merchant has an insight into a gap of $12 dollars with respect to the merchant's competitors that the merchant may attempt to reduce or eliminate with a customized campaign offer.

A fourth example chart 810 illustrates the average number of purchases at the merchant and at the merchant's competitors based on the anonymous transaction data. Specifically, in the example of FIG. 8, the merchant has 0.9 average number of purchases and the merchant's competitors have 2.3 average number of purchases. From this example chart 810, the merchant has an insight into a gap of 1.4 average number of purchases with respect to the merchant's competitors that the merchant may attempt to reduce or eliminate with a customized campaign offer.

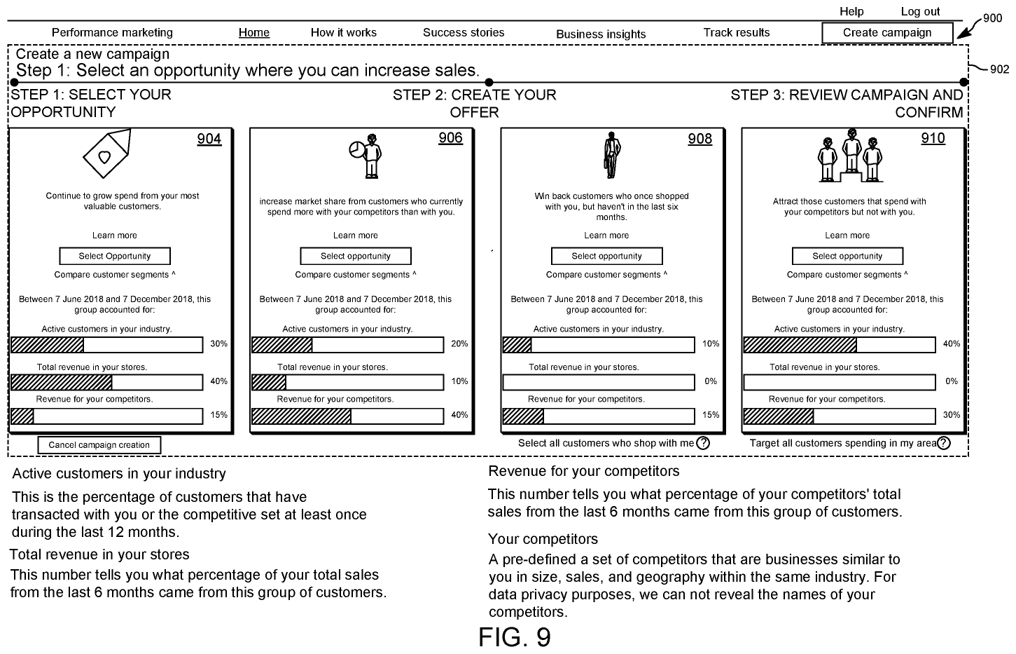

As illustrated in FIG. 9, a seventh example graphical user interface 900 is a campaign creation section 902 and includes several example customized campaign subsections 904-910 based on anonymous transaction data and over a six month time period. A first example customized campaign subsection 904 is a campaign for continuing the grow spend from the merchant's most valuable customers. Specifically, in the example of FIG. 9, the targeted customers in this campaign represent 30% of the active customers in the merchant's industry, 40% of the merchant's total revenue, and 15% of the revenue of the merchant's customers. From the seventh example graphical user interface 900, the merchant may select the first example customized campaign subsection 904 to start a targeted campaign at the merchant's most valuable customers and increase their total revenue in the merchant's stores from 40%.

A second example customized campaign 906 is a campaign for increasing market share from customers who currently spend more with the merchant's competitors than with the merchant. Specifically, in the example of FIG. 9, the targeted customers in this campaign represent 20% of the active customers in the merchant's industry, 10% of the merchant's total revenue, and 40% of the revenue of the merchant's customers. From the seventh example graphical user interface 900, the merchant may select the second example customized campaign 906 to start a targeted campaign at the merchant's competitors most valuable customers and increase their total revenue in the merchant's stores from 10%.

A third example customized campaign 908 is a campaign for winning back customers that shopped with the merchant, but not in the last six months. Specifically, in the example of FIG. 9, the targeted customers in this campaign represent 10% of the active customers in the merchant's industry, 0% of the merchant's total revenue, and 15% of the revenue of the merchant's customers. From the seventh example graphical user interface 900, the merchant may select the third example customized campaign 908 to start a targeted campaign at the merchant's previous customers and increase their total revenue in the merchant's stores from 0%.

A fourth example customized campaign 910 is a campaign for attracting customers that spend with the merchant's customers, but not with the merchant. Specifically, in the example of FIG. 9, the targeted customers in this campaign represent 40% of the active customers in the merchant's industry, 0% of the merchant's total revenue, and 30% of the revenue of the merchant's customers. From the seventh example graphical user interface 900, the merchant may select the fourth example customized campaign 910 to start a targeted campaign at only the merchant's competitors customers and increase their total revenue in the merchant's stores from 0%.

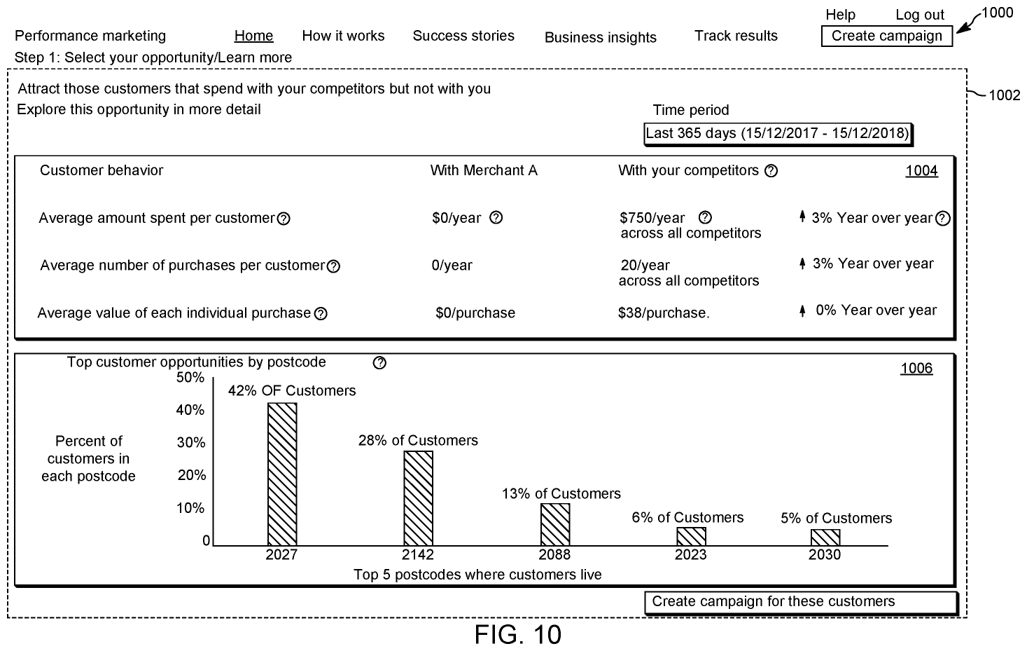

As illustrated in FIG. 10, an eighth example graphical user interface 1000 is a more detailed overview section 1002 from the selection of the fourth example customized campaign 910 and includes a comparison section 1004 and an example opportunities chart 1006 based on anonymous transaction data. The comparison section 1004 displays a comparison between the merchant and the merchant's competitors on 1) Average amount spent per customer, 2) Average number of purchases per customer, and 3) Average value of individual purchase. Specifically, in the example of FIG. 10, the targeted customers have never shopped with the merchant, but the same targeted customers average $750 per year across all competitors, average 20 purchases across all competitors, and average $38 per purchase.

The example opportunities 1006 illustrates the top opportunities by postcode. Specifically, in the example of FIG. 10, 42% of the merchant's competitors customers reside in postal code 2027, 28% of the merchant's competitors customers reside in postal code 2142, 13% of the merchant's competitors customers reside in postal code 2088, 6% of the merchant's competitors customers reside in postal code 2023, and 5% of the merchant's competitors customers reside in postal code 2030. From this example opportunities chart 1006, the merchant has an insight into the general localities of the targeted customers.

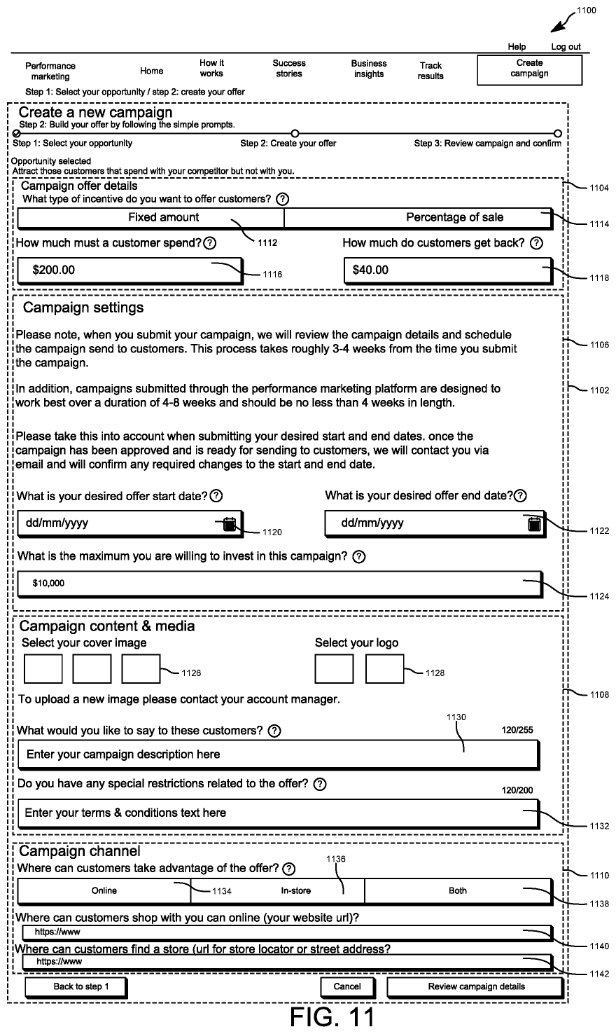

As illustrated in FIG. 11, a ninth example graphical user interface 1100 includes a campaign details section 1102 from selection of the fourth example customized campaign 910. The campaign details section 1102 includes a campaign offer details subsection 1104, a campaign settings subsection 1106, a campaign content and media subsection 1108, and a campaign channel subsection 1110.

The campaign offer details subsection 1104 includes two selectable graphical elements 1112 and 1114 and two fields 1116 and 1118. The first selectable graphical element 1112 sets the type of the incentive to offer the targeted customers as “fixed amount,” which results in the first field 1116 being a numerical field for entering how much a targeted customer must spend to satisfy the offer and the second field 1118 being a numerical field for entering how much a targeted customer gets back from satisfying the offer.

Alternatively, the second selectable graphical 1114 sets the type of the incentive to offer the targeted customers as “percentage of sale.” The first selectable graphical element 1112 sets the type of the incentive to offer the targeted customers as “percentage,” which results in the first field 1116 being a numerical field for entering how much a targeted customer may spend up while satisfying the offer and the second field 1118 being a numerical field for entering a percentage of how much a targeted customer gets back from satisfying the offer.

The campaign settings subsection 1106 includes three fields 1120-1124. The first field 1120 is date field for setting a desired date to start the campaign. The second field 1122 is a date field for setting a desired date to end the campaign. The third field 1124 is a numerical field for setting a maximum investment amount in the campaign.

The campaign content and media subsection 1108 includes two selectable graphical elements 1126 and 1128 and two fields 1130 and 1132. The first selectable graphical element 1126 sets the cover image of the campaign offer. The second selectable graphical element 1128 sets the logo of the campaign offer. The first field 1130 is a text field for entering a campaign description. The second field is 1132 is a text field for entering terms and conditions.

The campaign channel subsection 1110 includes three selectable graphical elements 1134-1138 and two fields 1140 and 1142. The first selectable graphical element 1134 is an “online” graphical element that controls whether only the first field 1140 is displayed in the campaign channel subsection 1110. The second selectable graphical element 1136 is an “in-store” graphical element that controls whether only the second field 1142 is displayed in the campaign channel subsection 1110. The third selectable graphical element 1138 is a “both” graphical element that controls whether both the first field 1140 and the second field 1142 are displayed in the campaign channel subsection 1110.

The first field 1140 is a text field for entering whether the targeted customers may shop online to redeem the offer (e.g., a website URL). The second field 1142 is a text field for entering where targeted customers may find the merchant's store to redeem the offer in-store (e.g., a street address or a store locator website URL).

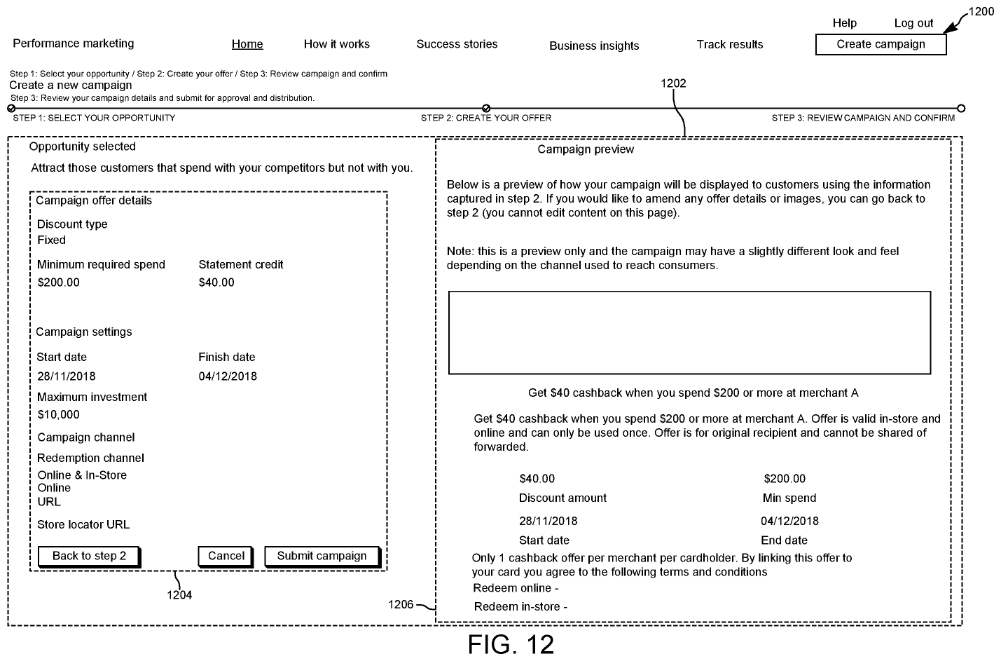

As illustrated in FIG. 12, a tenth example graphical user interface 1200 includes a campaign confirmation section 1202 from the finalization of the campaign details section 1102. The campaign confirmation section 1202 includes a campaign offer details confirmation subsection 1204 and a campaign preview subsection 1206.

The campaign offer details confirmation subsection 1204 confirms all of the graphical elements selected and information entered in the campaign details section 1102. The campaign preview subsection 1206 illustrates a preview of the campaign offer that will be presented to the targeted customers and based on the graphical elements selected and information entered in the campaign details section 1102.

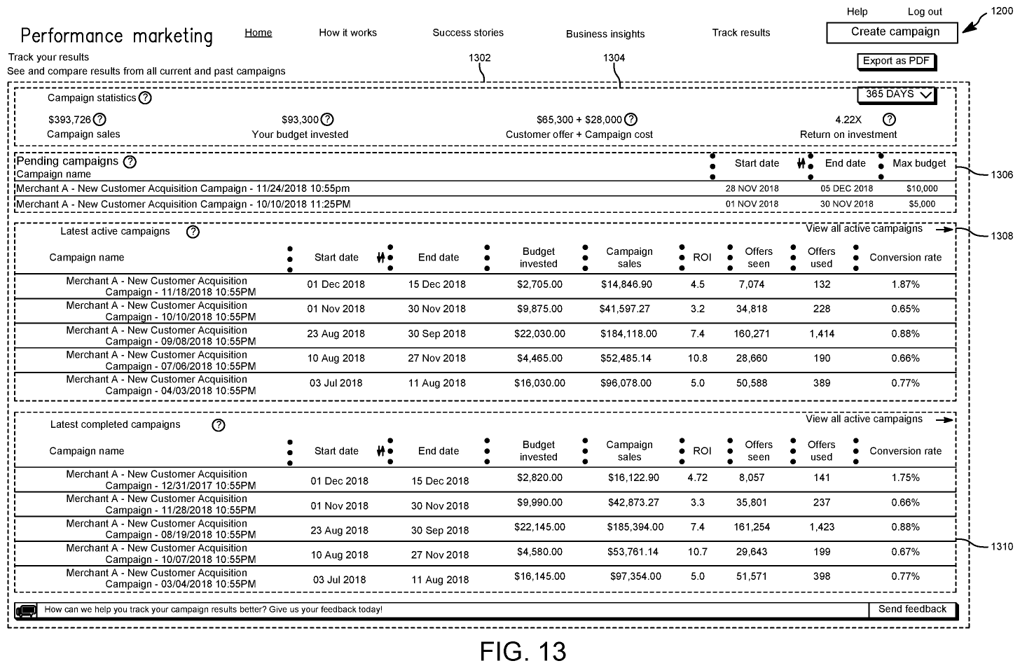

As illustrated in FIG. 13, an eleventh example graphical user interface 1300 includes a detailed overview section 1302 compared to the track your results section 602 and includes several example tracking results subsections 1304-1310 based on anonymous transaction data. The detailed overview section 1302 includes a campaign statistics subsection 1304, a pending campaigns subsection 1306, a latest active campaigns subsection 1308, and a latest completed campaigns subsection 1310.

The campaign statistics subsection 1304 includes campaign sales statistics, amount of budget invested in campaign (broken down between customer offer and campaign cost), and current return on investment.

The pending campaigns subsection 1306 includes a list of pending campaigns that have not yet been sent out to targeted customers. The list of pending campaigns includes a campaign name column, a start date column, an end date column, and a max budget column.

The latest active campaigns subsection 1308 includes a list of active campaigns that have been sent out to targeted customers. The list of active campaigns includes a campaign name column, a start date column, an end date column, a budget invested column, a campaign sales column, a return on investment (ROI) column, an offers seen column, an offers used column, and a conversion rate column. As explained above, in some examples, the campaign sales column, the ROI column, the offers seen column, the offers used column, and the conversion rate column are updated in real-time or near real-time.

The latest completed campaigns subsection 1310 includes a list of completed campaigns that have been completed. The list of active campaigns includes a campaign name column, a start date column, an end date column, a budget invested column, a campaign sales column, a return on investment (ROI) column, an offers seen column, an offers used column, and a conversion rate column.

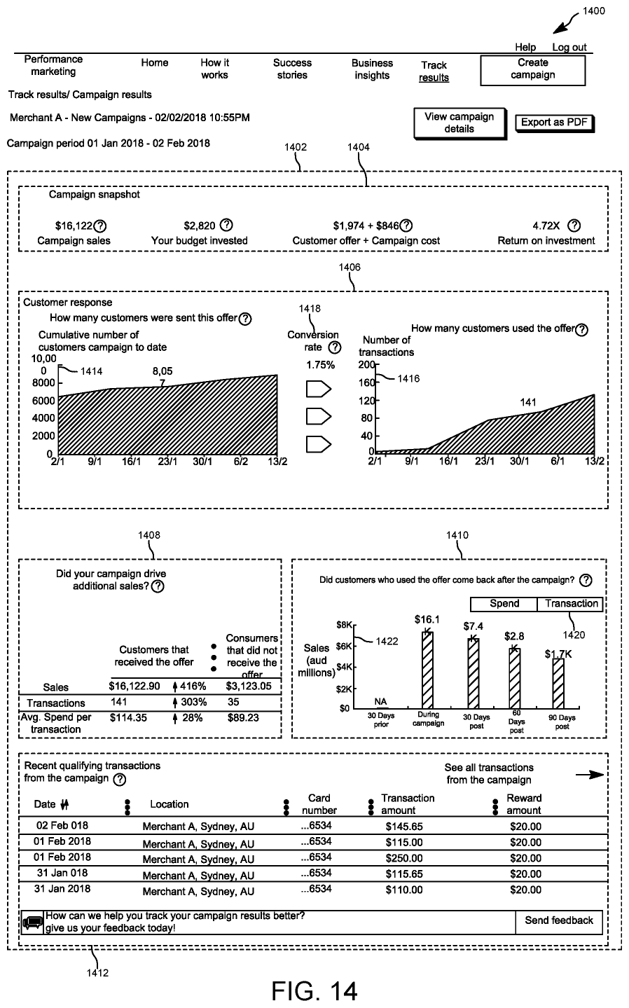

As illustrated in FIG. 14, a twelfth example graphical user interface 1400 includes a detailed overview section 1402 of a completed campaign and includes several example tracking results subsections 1404-1412 based on anonymous transaction data. The detailed overview section 1402 includes a campaign snapshot subsection 1404, a customer response subsection 1406, an additional sales subsection 1408, a loyalty subsection 1410, and a recent qualifying transactions subsection 1412.

The campaign snapshot subsection 1404 includes total campaign sales, amount of budget invested in campaign (broken down between customer offer and campaign cost), and the total return on investment.

The customer response subsection 1406 includes two targeted customer charts 1414 and 1416 and a conversion rate 1418. The first targeted customer chart 1414 displays the cumulative number of customers sent the offer over time. The second targeted customer chart 1416 displays the cumulative number of customers that used the offer over the same time period as the first targeted customer chart 1414. The conversion rate 1418 is a percentage of the targeted customers that used the offer.

The additional sales subsection 1408 includes a chart with a sales row, a transactions row, an average spend per transaction row, a targeted customer column, and a non-targeted customers column. In the example of FIG. 14, the sales row includes $16,122.90 for targeted customers (i.e., the targeted customers column) and $3,123.05 for non-targeted customers (i.e., the non-targeted customers column), which is 416% in additional sales for targeted customers versus non-targeted customers. The transactions row includes 141 transactions for targeted customers and 35 transactions for non-targeted customers, which is 303% in additional transactions for targeted customers versus non-targeted customers. The average spend per transaction row includes an average of $114.35 spent per transaction for targeted customers and an average of $89.23 spent per transaction for non-targeted customers, which is 28% in additional average spend per transaction for targeted customers versus non-targeted customers.

The loyalty subsection 1410 includes a selectable graphical element 1420 and a chart 1422 that illustrates sales of the targeted customers before, during, and after the campaign when “spend” is selected in the selectable graphical element 1420. The chart 1422 may also illustrate transactions of the targeted customers before, during, and after the campaign when “transaction” is selected in the selectable graphical element.

The recent qualifying transactions subsection 1412 is a list of recent qualifying transactions that have been completed and satisfy the offer. The list of recent qualifying transactions includes a transaction date column, a location column, a card number column, a transaction amount column, and a reward amount column.

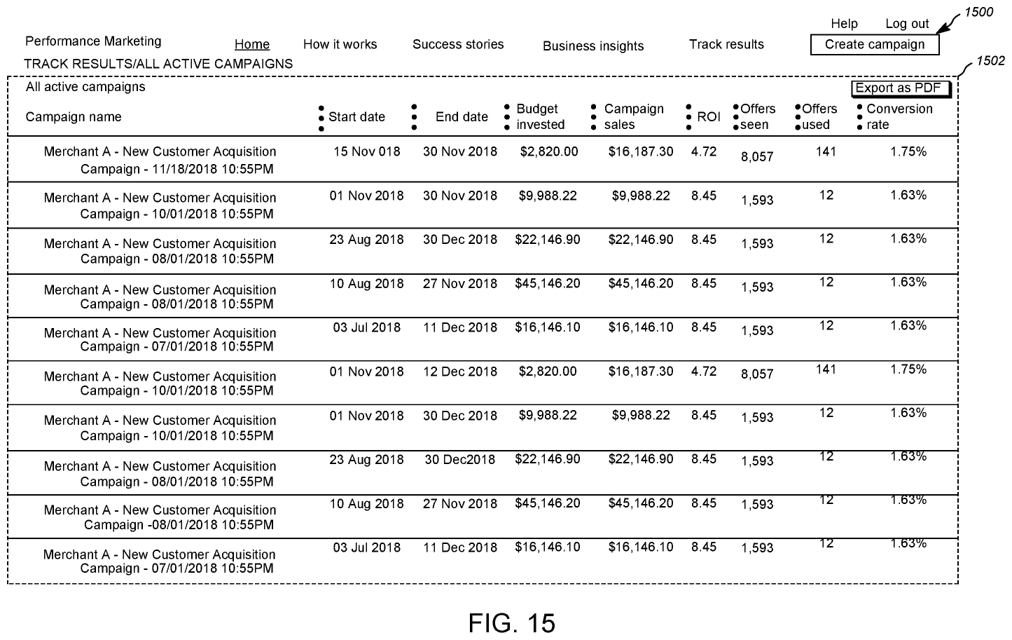

As illustrated in FIG. 15, a thirteenth example graphical user interface 1500 includes an active campaigns overview section 1502. The active campaigns overview section 1502 includes a list of active campaigns. The list of active campaigns includes rows of active campaigns with specific information in a campaign name column, a start date column, an end date column, a budget invested column, a campaign sales column, a return on investment (ROI) column, an offers seen column, an offers used column, and a conversion rate column.

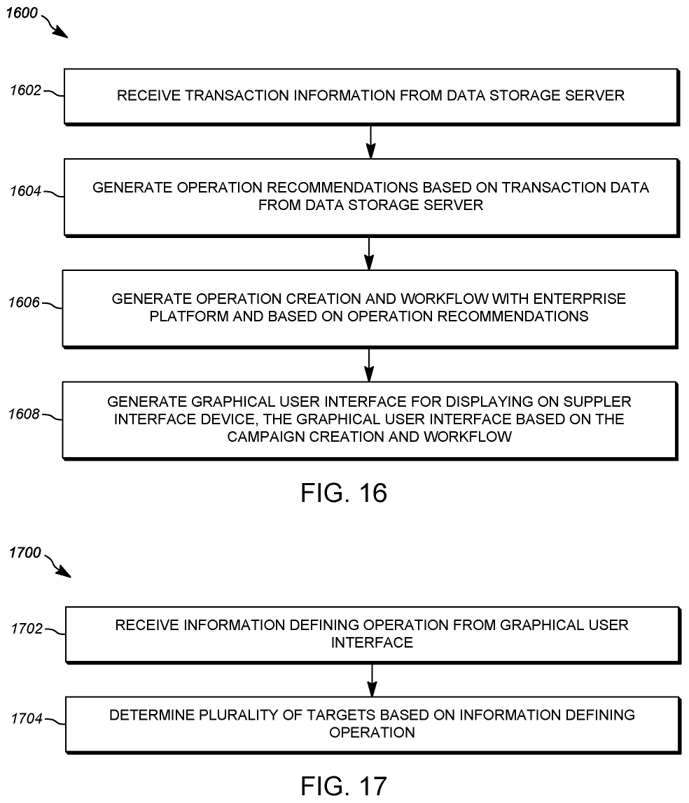

FIGS. 16-18 are flowcharts illustrating example methods 1600-1800 performed by the digital advertisement system 10 of FIG. 1. In the example of FIG. 16, the method 1600 includes the electronic processor 102 of the server 100 receiving transaction information from the data storage server 120 (at block 1602). The method 1600 includes the electronic processor 102 generating campaign recommendations based on the transaction data from the data storage server 120 (at block 1604). For example, the campaign creation section 902 as described above with respect to FIG. 9.

The method 1600 includes the electronic processor 102 generating campaign creation and workflow with the enterprise offer program 108 and based on campaign recommendations (at block 1606). For example, the detailed overview section 1002 as described above with respect to FIG. 10.

The method 1600 includes the electronic processor 102 generating a graphical user interface for displaying on the merchant interface device 160, the graphical user interface based on the campaign creation and workflow (at block 1608). For example, the campaign details section 1102 as described above with respect to FIG. 11.

In the example of FIG. 17, the method 1700 includes the electronic processor 102 receiving information defining a campaign from the graphical user interface (at block 1702). For example, receiving information from the campaign details section 1102 as described above with respect to FIG. 11.

The method 1700 also includes the electronic processor 102 determining a plurality of targets based the information defining the campaign (at block 1704). For example, the maximum investment amount in the field 1124 is output to be used in performing the personalized card-linked offer program 110. The electronic processor 102 may use this information to determine a plurality of targets (e.g., customers that have not shopped with the merchant).

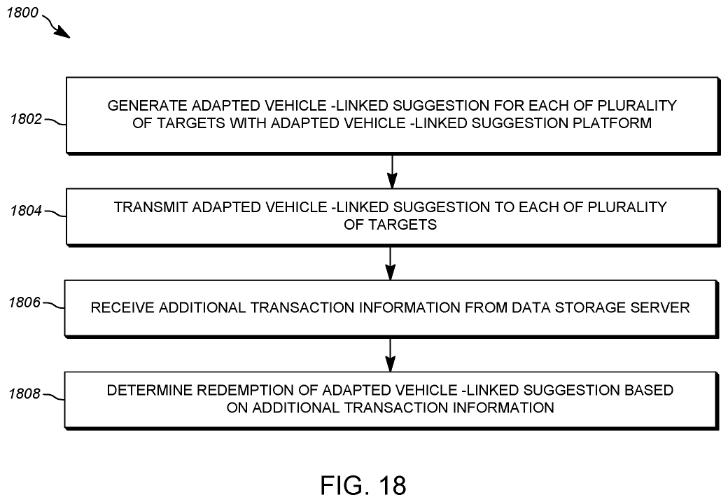

In the example of FIG. 18, the method 1800 includes the electronic processor 102 generating a personalized card-linked offer for each of the plurality of targets with the personalized card-linked offer program 110 (at block 1802).

The method 1800 includes the electronic processor 102 transmitting the personalized card-linked offer to each of the plurality of targets (at block 1804). For example, the electronic processor 102 controls the communication interface 112 to transmit a personalized card-linked offer to the cardholder interface device 180.

The method 1800 includes the electronic processor 102 receiving additional transaction information from the data storage server 120 (at block 1806). The method 1800 also includes the electronic processor 102 determining redemption of personalized card-linked offer based on the additional transaction information (at block 1808). As explained above, the determination of the redemption may be in real-time or near real-time.

The following is a list of features that further defines the digital advertisement system 10 as described above with respect to FIGS. 1-18. However, the following list of features is a non-limiting example, and other features may be understood from the above disclosure of the digital advertisement system 10. One feature is a self-service campaign creation feature that provides for merchants to directly access the enterprise offer platform (or alternative solution) to create their own campaigns, which provides more merchant control/autonomy and decreases operational burden for the advertiser. Another feature is a near-real time redemption notification provides for cardholders to receive a near-real time notification upon offer redemption event, based on the authorization stream. For example, the platform may push a notification to the distribution partner who then may form/pass the message to the appropriate cardholder. Another feature is a geographic relevance feature that provides additional geo-based capabilities. In particular, the ability to scalably provide filtering/sorting of offers based on user's current location (provided to the platform via mobile device calling the API). Further aspects of geo-capability may include geo-based offer qualification.

Another feature is an automated campaign recommendations feature that provides for an automated system to provide intelligent recommendations to guide advertisers in campaign creation based on transactional information. Another feature is a program management feature that provides for enhancement and automation of key operational management functions and may reduce the operational burden in a scaled program (e.g. to the SME segment) and should also provide more robust/reliable program execution (via lesser dependency on manual operations). Yet another feature is a self-service reporting (existing reports) feature that provides for a web portal where registered merchants may log-in and view campaign performance reporting. Similar to currently existing standard reports/dashboards, with near-real-time updates.

Another feature is an expanded reporting and analytics feature that includes the development and automation of incremental types of reporting for program stakeholders (especially merchants and distribution partners). For example, reports that are currently being developed manually in the market and other analytics for which there is a market need. Another feature is an incorporating partner-provided data feature that provides for the platform to ingest (and use) incremental data from distribution partners (or other external sources). This may be beyond data that is already allowed in the context of standard consumer enrollment, as well as the custom segment indicator. Examples may be travel profiles, product usage data, demographic data, or other suitable partner data. Yet another feature is a SKU data feature that provides for the access/ingestion of SKU-level data, potentially for only a subset of retailers. This data may then be used to enable SKU-level offers which provide rewards for buying specific items from specific stores. Importantly, SKU-level offers may provide optionality to receive offer sponsorship/funding from manufacturers (in addition to retailers). The SKU data feature may also include the ability to target SKU-level offers to individuals based on their historic SKU-level purchase data.

Another feature is a targeting and redemption modes feature that provides for a wide variety of targeting options (i.e. merchant, category, geography, category share, etc.) in addition to targeting using additional data-sets (i.e. demographic data or other metadata provided by enrollment sources or directly by cardholders.) The targeting and redemption modes feature supports a range of redemption options (since purchase, multi-visit, single redemption merchant vs multiple merchants, etc.) in addition to support for additional offer constructs, including redemption in foreign countries, location-specific offers, time of day redemptions, etc. Another feature is an enhanced propensity analytics feature makes the offer matching process more “intelligent” and “dynamic”, even while keeping the data set/signals available to the server 100 constant. The upside of the enhanced propensity analytics feature is the increase in likelihood the server 100 matches the right user with the right offer at the right time, which may yield a higher offer engagement rate, and in turn, a higher monetization rate per offer impression. Further capability in this feature area contemplates incorporating additional datasets, leveraging artificial intelligence, etc. Yet another feature is an automated budget management feature that provides for a more intelligent/automated approach to budget management for each offer campaign.

Another feature is an aggregator-level views features feature that provides for a “roll-up” view or controls within the graphical user interfaces described herein (e.g., reporting and/or campaign creation) that provides an entity, such as a merchant content aggregator, the ability to enable management/monitoring/configuration within the product. Another feature is an enhanced APIs feature that provides for additional functionality, especially in the form of additional methods based on market use-cases. The ability to connect to distribution partners that are not financial institutions may drive additional requirements. Yet another feature is a contextual relevance feature that provides for offer filtering/prioritization based on contextual signals (other than current location, which is covered in a separate line item). Examples of contextual signals include weather, time of day, special events, or other suitable contextual signals.

Another feature is an explicit user feedback/favorite offers feature that provides a more explicit feedback loop by which cardholders may signal their likes/preferences which may then be directly incorporated into the offer matching/scoring processes. Another feature is a turnkey presentment feature that provides for the platform to support direct communication with the end-consumer (which necessitates PII data at time of enrollment). Yet another feature is a channel optimization feature that adds a level of intelligence to help drive more yield per presentment opportunity.

Another feature is an automated invoicing payment process feature that provides an ability to take the amount off the initial transaction from the merchant either automatically assigned to customer or assigned to customer after an additional step which puts a validation against the transaction. This may also include the ability to take the campaign fee off the transaction as well. Another feature is a refund management feature that manages the claw back of a reward if a customer returns the item within a certain period, including the potential ability for merchant to identify relevant refund transactions and initiate the claw back process. Yet another feature is a fixed amount threshold feature sets a threshold at a specified dollar amount, not just any amount above the threshold.

Another feature is a loyalty points engine feature that provides for earning rewards based on budget spent on the platform to then redeem against a variety of options, e.g., bonus redemptions, placement, obtaining a tier status, or other suitable redemption options. Lastly, another feature is a program selection feature that provides for a merchant to select which third-party program they want to participate in (for example, an airline frequent flyer program, a hotel loyalty program, or other suitable third-party program). The third-party program selection feature also has the ability for owners of the third-party program to make their program open to certain merchants and to block other merchants.

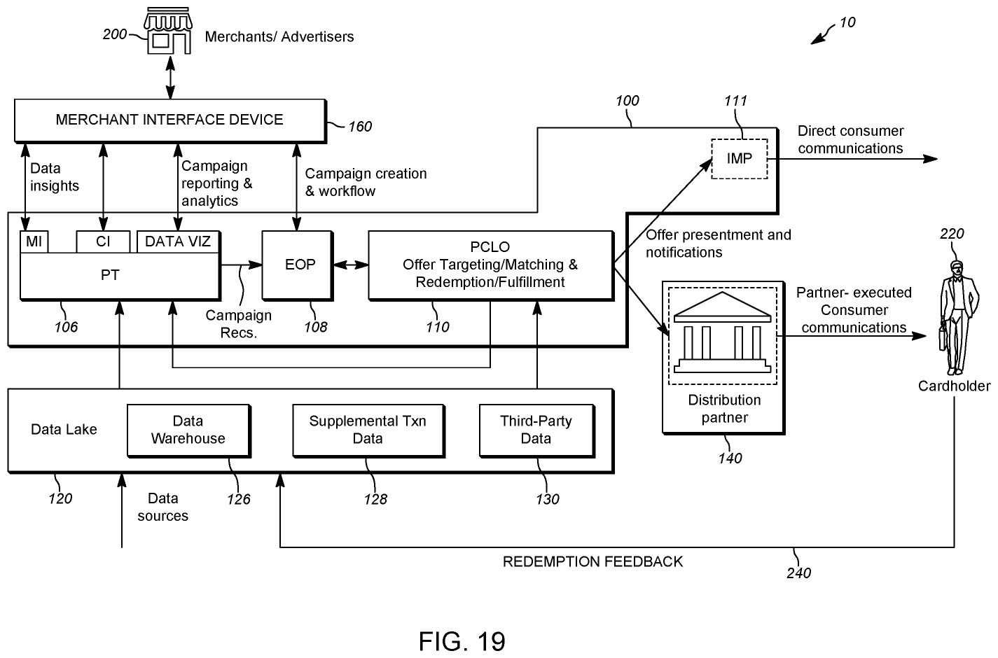

FIG. 19 is a diagram illustrating a second example of relationships between various components of the digital advertisement system 10 of FIG. 1. In the example of FIG. 19, the digital advertisement system 1900 includes the server 100, the data storage server 120, the distribution partner server 140, the merchant interface device 160, and the cardholder interface device 180. Additionally, in the example of FIG. 19, the digital advertisement system 1900 further includes a merchant 200 and a targeted cardholder 220.

The difference between FIG. 19 and FIG. 2 is the applied predictive technologies program 106 provides data visualization (e.g., campaign reporting and analytics) and campaign recommendations instead of the personalized card-linked offer program 110. As illustrated in FIG. 19, the electronic processor 102, in performing the applied predictive technologies program 106, retrieves information from the data storage server 120, and in the case of an existing campaign, information generated by performing the personalized card-linked offer program 110. Upon receiving the information from the data storage server 120, the electronic processor 102, in performing the applied predictive technologies program 106, uses machine learning to generate market insights, consumer insights, data visualization (e.g., campaign reporting and analytics), and campaign recommendations.

The electronic processor 102 outputs the market insights, consumer insights, and data visualization to the merchant interface device 160. For example, the electronic processor 102 generates a webpage that is accessible by the merchant interface device 160. The webpage includes the market insights, the consumer insights, and the data visualization. In this way, the merchant 200 has direct access to the applied predictive technologies program 106 and the ongoing analytics of an existing campaign or predictions for a future campaign in the server 100.

The electronic processor 102, in performing the applied predictive technologies program 106, outputs the campaign recommendations that are generated to the enterprise offer program 108. The electronic processor 102, in performing the enterprise offer program 108, generates a campaign creation and workflow based on the campaign recommendations. The electronic processor 102 controls the communication interface 112 to output the campaign creation and workflow to the merchant interface device 160. For example, the electronic processor 102 generates a webpage for the merchant interface device 160 to access. The webpage includes the campaign creation and workflow. The electronic processor 102 then receives information defining a specific campaign from the merchant 200 based on the merchant's use of the campaign creation and workflow in the webpage. In this way, the merchant 200 has direct access to the enterprise offer program 108 and the specific creation of a campaign in the server 100.

As illustrated in FIG. 19, the electronic processor 102, in performing the personalized card-linked offer program 110, receives transaction information from the data storage server 120 and determines a plurality of targets (e.g., a plurality of cardholders including the cardholder 220) based on the transaction information that is received and the information defining the specific campaign. Upon determining a plurality of targets, the electronic processor 102, in performing the personalized card-linked offer program 110, generates an offer presentment and notifications for each of the plurality of targets. In some examples, the electronic processor 102 controls the communication interface 112 to output the offer presentment and notifications to the distribution partner server 140 for partner-executed consumer communications. In other examples, the electronic processor 102, in performing the optional integrated marketing program 111, controls the communication interface 112 to output the offer presentment and notifications for direct consumer communications from the server 100. For example, the electronic processor 102 may control the communication interface 112 to output the offer present and notifications directly to the cardholder interface device (not shown) and the cardholder 220.

In some embodiments, the cardholder 220 may be required to activate the offer from the server 100. Upon activation by the cardholder 220, the offer may be redeemed by satisfying the offer. The electronic processor 102, in performing the personalized card-linked offer program 110, determines the offer has been satisfied based on the transaction data associated with the cardholder 220 that indicates a redemption by the cardholder 220 (illustrated by the redemption feedback 240). Upon redemption of the offer, electronic processor 102, in performing the personalized card-linked offer program 110, outputs a fulfillment notification to the cardholder 220 and applies the incentive of the offer to the account of the cardholder 220. Additionally, upon redemption of the offer, the electronic processor 102, in performing the personalized card-linked offer program 110, outputs the fulfillment information for use by the electronic processor 102 in performing the applied predictive technologies program 106.

In other embodiments, the offer to the cardholder 220 may be pre-activated from the server 100. The offer may be redeemed simply by satisfying the offer. The electronic processor 102, in performing the personalized card-linked offer program 110, determines the offer has been satisfied based on the transaction data associated with the cardholder 220 that indicates a redemption by the cardholder 220 (illustrated by the redemption feedback 240). Upon redemption of the offer, the electronic processor 102, in performing the personalized card-linked offer program 110, outputs a fulfillment notification to the cardholder 220 and applies the incentive of the offer to the account of the cardholder 220. Additionally, upon redemption of the offer, the electronic processor 102, in performing the personalized card-linked offer program 110, outputs the fulfillment information for use in performing the applied predictive technologies program 106.

The electronic processor 102, in performing the applied predictive technologies program 106, updates the campaign reporting and analytics based on the fulfillment information received from performing the personalized card-linked offer program 110. Upon updating the campaign reporting and analytics, the merchant 200 may see the fulfillment by the cardholder 220 on the webpage. In some examples, the merchant 200 may see the fulfillment by the cardholder 220 on the webpage and in real-time. In other examples, the merchant 200 may see the fulfillment by the cardholder 220 on the webpage and in near real-time (e.g., within the same day). In yet other examples, the merchant 200 may see the fulfillment by the cardholder 220 on the webpage and within twenty-four to forty-eight hours.

Thus, the present disclosure provides, among other things, a digital advertisement platform with redemption feedback. Various features and advantages of the invention are set forth in the following claims.

What is claimed is:

1. A server comprising:
a communication interface configured to:
communicate with a supplier interface device,
communicate with a vehicle-holder interface device, and
communicate with a data storage server;
a memory; and
an electronic processor communicatively connected to the memory, the electronic processor configured to
receive transaction information from the data storage server,
generate operation recommendations based on the transaction information that is received from the data storage server,
generate operation creation and workflow with an enterprise platform stored in the memory and based on the operation recommendations, and
generate a graphical user interface for displaying on the supplier interface device, the graphical user interface based on the operation creation and workflow.

2. The server of claim 1, wherein the electronic processor is further configured to receive information defining an operation from the graphical user interface.

3. The server of claim 2, wherein the information includes a spend threshold, a reward amount, a start date, an end date, and an operation investment amount.

4. The server of claim 2, wherein the graphical user interface includes one or more customized operation opportunities, and wherein, to receive the information defining the operation from the graphical user interface, the electronic processor is further configured to receive a selection of one of the one or more customized operation opportunities.

5. The server of claim 2, wherein the electronic processor is further configured to determine a plurality of targets based on the information defining the operation.

6. The server of claim 5, wherein the electronic processor is further configured to
generate an adapted vehicle-linked suggestion for each of the plurality of targets with an adapted vehicle-linked suggestion platform stored in the memory,
transmit the adapted vehicle-linked suggestion to the each of the plurality of targets,
receive additional transaction information from the data storage server after transmitting the adapted vehicle-linked suggestion to the each of the plurality of targets, and
determine redemption of the adapted vehicle-linked suggestion based on the additional transaction information.

7. The server of claim 6, wherein the electronic processor is further configured to
generate operation reporting and analysis with an applied predictive technologies platform stored in the memory and based on the additional transaction information that is received from the data storage server, and
generate a second graphical user interface for displaying on the supplier interface device, the second graphical user interface including the operation reporting and analysis.

8. The server of claim 6, wherein the electronic processor is further configured to determine the redemption of the adapted vehicle-linked suggestion based on the additional transaction information in real-time or near real-time.

9. A system comprising:
a supplier interface device;
a vehicle-holder interface device;
a data storage server; and
a server including
a communication interface configured to:
communicate with the supplier interface device,
communicate with the vehicle-holder interface device, and
communicate with the data storage server;
a memory; and
an electronic processor communicatively connected to the memory, the electronic processor configured to
receive transaction information from the data storage server,
generate operation recommendations based on the transaction information that is received from the data storage server,
generate operation creation and workflow with an enterprise platform stored in the memory and based on the operation recommendations, and
generate a graphical user interface for displaying on the supplier interface device, the graphical user interface based on the operation creation and workflow.

10. The system of claim 9, wherein the electronic processor is further configured to receive information defining an operation from the graphical user interface.

11. The system of claim 10, wherein the information includes a spend threshold, a reward amount, a start date, an end date, and an operation investment amount.

12. The system of claim 10, wherein the graphical user interface includes one or more customized operation opportunities, and wherein, to receive the information defining the operation from the graphical user interface, the electronic processor is further configured to receive a selection of one of the one or more customized operation opportunities.

13. The system of claim 10, wherein the electronic processor is further configured to determine a plurality of targets based on the information defining the operation.

14. The system of claim 13, wherein the electronic processor is further configured to
generate an adapted vehicle-linked suggestion for each of the plurality of targets with an adapted vehicle-linked suggestion platform stored in the memory,
transmit the adapted vehicle-linked suggestion to the each of the plurality of targets,
receive additional transaction information from the data storage server after transmitting the adapted vehicle-linked suggestion to the each of the plurality of targets, and
determine redemption of the adapted vehicle-linked suggestion based on the additional transaction information.

15. The system of claim 14, wherein the electronic processor is further configured to
generate operation reporting and analysis with an applied predictive technologies platform stored in the memory and based on the additional transaction information that is received from the data storage server, and
generate a second graphical user interface for displaying on the supplier interface device, the second graphical user interface including the operation reporting and analysis.

16. The system of claim 14, wherein the electronic processor is further configured to determine the redemption of the adapted vehicle-linked suggestion based on the additional transaction information in real-time or near real-time.

17. A method comprising:
receiving, with a server, transaction information from a data storage server;
generating, with the server, operation recommendations based on the transaction information that is received from the data storage server;
generating, with the server, an operation creation and workflow with an enterprise platform and based on the operation recommendations; and
generating, with the server, a graphical user interface for displaying on a supplier interface device, the graphical user interface based on the operation creation and workflow.

18. The method of claim 17, further comprising:
receiving, with the server, information defining an operation from the graphical user interface; and
determining a plurality of targets based on the information defining the operation.

19. The method of claim 18, further comprising:
generating an adapted vehicle-linked suggestion for each of the plurality of targets with an adapted vehicle-linked suggestion platform;
transmit the adapted vehicle-linked suggestion to the each of the plurality of targets;
receive additional transaction information from the data storage server after transmitting the adapted vehicle-linked suggestion to the each of the plurality of targets; and
determine redemption of the adapted vehicle-linked suggestion based on the additional transaction information.

20. A non-transitory computer-readable medium comprising instructions that, when executed by an electronic processor, cause the electronic processor to perform a set of operations comprising:
receiving transaction information from a data storage server;
generating operation recommendations based on the transaction information that is received from the data storage server;
generating an operation creation and workflow with an enterprise platform and based on the operation recommendations; and
generating a graphical user interface for displaying on a supplier interface device, the graphical user interface based on the operation creation and workflow.
